(19) United States
(12) Patent Application Publication
(10) Pub. No.: US 2019/0302544 A1
(43) Pub. Date: Oct. 3, 2019

(54) PIXEL ELECTRODE, ARRAY SUBSTRATE, AND LIQUID CRYSTAL DISPLAY PANEL

(71) Applicant: Wuhan China Star Optoelectronics Technology Co., Ltd., Wuhan (CN)

(72) Inventor: Wenqing Song, Shenzhen (CN)

(21) Appl. No.: 16/120,463

(22) Filed: Sep. 4, 2018

Related U.S. Application Data
(63) Continuation of application No. PCT/CN2018/096507, filed on Jul. 20, 2018.

(30) Foreign Application Priority Data
Mar. 30, 2018 (CN) 201810290638.1

(51) Int. Cl. G02F 1/1343

(52) U.S. Cl. CPC G02F 1/134309; G02F 1/134363; G02F 2001/134372; G02F 2201/122; G02F 2201/123; G02F 2001/134345

(57) ABSTRACT

The present disclosure provides a pixel electrode, an array substrate, and a liquid crystal display panel. The pixel electrode may include a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides. An active region of the liquid crystal molecules may become smaller. The liquid crystal molecules may reach a maximum twist angle quickly, thereby a response speed of a liquid crystal display may be improved.

### CROSS-REFERENCE TO RELATED APPLICATIONS

The present application is a continuation-application of International (PCT) Patent Application No. PCT/CN2018/096507, filed on Jul. 20, 2018, which claims foreign priority of Chinese Patent Application No. 201810290638.1, filed on Mar. 30, 2018 in the State Intellectual Property Office of China, the entire contents of which are hereby incorporated by reference.

### FIELD

The described embodiments relate to a display technology, and more particularly, to a pixel electrode, an array substrate and a liquid crystal display panel.

### BACKGROUND

Fringe field switching (FFS) type liquid crystal display has advantages of high penetration, wide viewing angle, etc., and has been widely used in small and medium size displays. Liquid crystal molecules in a liquid crystal cell of the FFS type liquid crystal display may be rotated in a plane parallel to the substrate by a boundary electric field. Thereby an optical path difference may be generated, to achieve a display effect.

Although an existing FFS type liquid crystal display performs well in screen displaying, color, viewing angle, etc., a response time is relatively slow. The FFS type liquid crystal display has a great influence to a virtual reality (VR) when used in a normal temperature, and a dynamic blur effect may be occurred. In an environment of a low-temperature car display, an influence due to temperature may become large, because the liquid crystal molecules may rotate more slowly in the environment of low-temperature. A delay in response may be occurred, thereby a dynamic blur effect may be occurred.

Therefore, it is necessary to provide a pixel electrode, an array substrate, and a liquid crystal display panel to solve the above-mentioned technical problem.

### SUMMARY

The present disclosure provides a pixel electrode, an array substrate, and a liquid crystal display panel, which may solve a technical problem. The pixel electrode of the present disclosure may make liquid crystal molecules to reach a maximum twist angle quickly, thereby a response speed of a liquid crystal display may be improved.

In order to solve the above-mentioned technical problem, a technical solution adopted by the present disclosure is to provide a pixel electrode comprising a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides.

In order to solve the above-mentioned technical problem, a technical solution adopted by the present disclosure is to provide an array substrate comprising a pixel unit; the pixel unit comprising a plurality of sub-pixels, and each of the sub-pixels comprising a pixel electrode, wherein the pixel electrode comprises a plurality of sub-pixel electrodes and an intermediate portion; the plurality of sub-pixel electrodes are coupled to each other by the intermediate portion, wherein each of the sub-pixel electrodes is more linearly narrowed from the intermediate portion away both sides.

In order to solve the above-mentioned technical problem, a technical solution adopted by the present disclosure is to provide a liquid crystal display panel comprising an array substrate; the array substrate comprising a pixel unit; the pixel unit comprising a plurality of sub-pixels, and each of the sub-pixels comprising a pixel electrode, wherein the pixel electrode comprises a plurality of sub-pixel electrodes and an intermediate portion; the plurality of sub-pixel electrodes are coupled to each other by the intermediate portion, wherein each of the sub-pixel electrodes is more linearly narrowed from the intermediate portion away both sides.

Advantages of the disclosure may follow. As compared with the related art, the present disclosure may provide a pixel electrode comprising a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides. An active region of the pixel electrode where liquid crystal molecules are located may be divided into more and smaller cells, so that the active region where the liquid crystal molecules are located may become smaller. The liquid crystal molecules may reach a maximum twist angle quickly, thereby a response speed of a liquid crystal display may be improved.

### BRIEF DESCRIPTION OF THE DRAWINGS

FIG. 1A is a structural illustration of a pixel electrode in accordance with an embodiment in the present disclosure.

FIG. 1B is a structural illustration in a top view of an arrangement of liquid crystal molecules controlled by an electric field after the pixel electrode shown in FIG. 1 is power-on.

FIG. 2A is a cross section structural illustration of an array substrate in accordance with an embodiment in the present disclosure.

FIG. 2B is a structural illustration in a top view of an array substrate in accordance with an embodiment in the present disclosure.

FIG. 3 is a structural illustration of a liquid crystal display panel in accordance with an embodiment in the present disclosure.

### DETAILED DESCRIPTION

The detailed description set forth below is intended as a description of the subject technology with reference to the appended figures and embodiments. It is understood that the embodiments described herein include merely some parts of the embodiments of the present disclosure, but do not include all the embodiments. Based on the embodiments of the present disclosure, all other embodiments that those skilled in the art may derive from these embodiments are within the scope of the present disclosure.

A pixel unit may include at least two sub-pixels. The pixel unit may include three sub-pixels of red (R), green (G), and blue (B). Each of the sub-pixels may include a pixel electrode. The pixel electrodes of each of the sub-pixels may be independently controlled. In order to improve a response speed of a liquid crystal display, the present disclosure provides a pixel electrode including a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides. In the present disclosure, the intermediate portion and the plurality of sub-pixel electrodes connected to the intermediate portion may be integrated as a whole, and the whole may be treated as one pixel electrode. Hereinafter, a specific description will be given by taking an example in which one pixel electrode includes three sub-pixel electrodes, and each sub-pixel electrode includes a pair of trapezoidal portions.

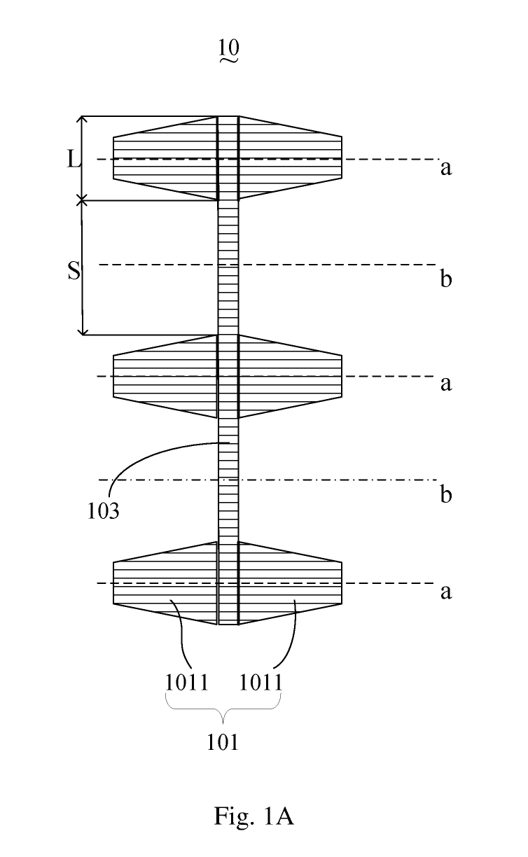

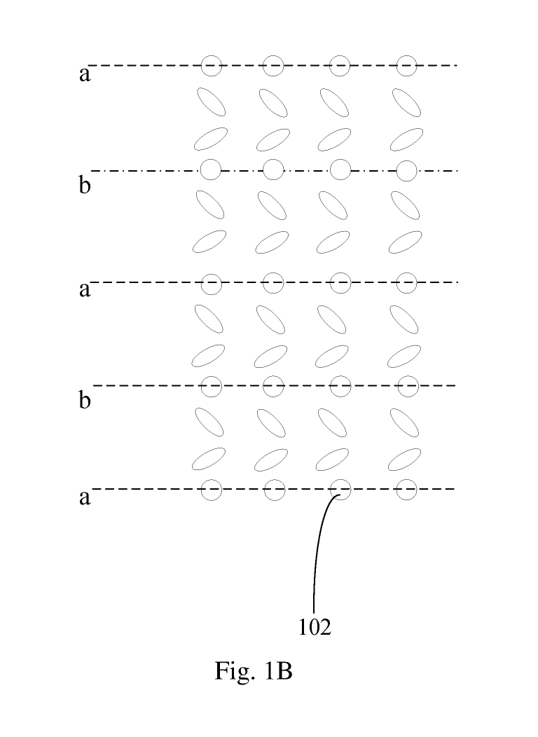

Referring to FIG. 1A, FIG. 1A is a structural illustration of a pixel electrode in accordance with an embodiment in the present disclosure. The pixel electrode 10 may include three sub-pixel electrodes 101 and an intermediate portion 103. The three sub-pixel electrodes 101 may be coupled to each other by the intermediate portion 103. The three sub-pixel electrodes 101 may include a pair of trapezoidal portions 1011 arranged symmetrically with the intermediate portion 103 as an axis. A shape of the trapezoidal portion 1011 in a top view may be an isosceles trapezoid, and a shape of the intermediate portion 103 in a top view may be a rectangle. The pair of trapezoidal portions 1011 may be arranged opposite to each other with its bottom base sides. The bottom base sides of the pair of trapezoidal portions 1011 may be connected to the intermediate portion 103. An angle between a lateral side of the trapezoidal portion 1011 and the bottom base side of the trapezoidal portion 1011 may be 84 degrees to 87 degrees. The letter L in FIG. 1A may refer to a length of the bottom base side of the trapezoidal portion 1011, and the letter S may refer to a distance between two of the adjacent pairs of trapezoidal portions 1011. The intermediate portion 103 and the three sub-pixel electrodes 101 coupled to each other by the intermediate portion 103 may be integrated as a whole, and the whole may be treated as a single pixel electrode.

In an embodiment, the pixel electrode 10 may include three of the sub-pixel electrodes 101. In other embodiments, the pixel electrode 10 may also include two, four, five or other numbers of the sub-pixel electrodes 101. It is not limited herein.

In an embodiment, the shape of the trapezoidal portion 1011 in a top view may be an isosceles trapezoid. In other embodiments, the shape of the trapezoidal portion 1011 in a top view may be other types of trapezoidal. It is not limited herein.

When in a condition that the length of the bottom base side of the trapezoidal portion 1011 and the distance between two of the adjacent pairs of trapezoidal portions 1011 are kept a constant, and the angle between a lateral side of the trapezoidal portion 1011 and the bottom base side of the trapezoidal portion 1011 is changed, it is found after a large number of simulation tests that when the angle between a lateral side of the trapezoidal portion 1011 and the bottom base side of the trapezoidal portion 1011 is 84.9 degrees to 85.2 degrees, a response speed of liquid crystal molecules may be accelerate, i.e., the angle between a lateral side of the isosceles trapezoid and the bottom base side of the isosceles trapezoid may be 84.9 degrees to 85.2 degrees in a top view.

Optionally, the angle between a lateral side of the isosceles trapezoid and the bottom base side of the isosceles trapezoid may be about 85.05 degrees in a top view.

When in a condition that the angle between a lateral side of the trapezoidal portion 1011 and the bottom base side of the trapezoidal portion 1011 is kept a constant, and the length of the bottom base side of the trapezoidal portion 1011 and the distance between two of the adjacent pairs of trapezoidal portions 1011 are changed, it is found after a large number of simulation tests that when the length of the bottom base side of the trapezoidal portion 1011 is 3.6 micrometers to 4.6 micrometers, and the distance between two of the adjacent pairs of trapezoidal portions 1011 is 3.6 micrometers to 4.6 micrometers, the response speed of the liquid crystal molecules may be accelerate.

Optionally, the length of the bottom base side of the trapezoidal portion 1011 may be about 4.1 micrometers, and the distance between two of the adjacent pairs of trapezoidal portions 1011 may be about 4.1 micrometers.

In other embodiment, a length of the upper base side of the trapezoidal portion 1011 may be less than the length of the bottom base side of the trapezoidal portion 1011, and the length of the upper base side may be greater than one quarter of the length of the bottom base side.

In an embodiment, a material of the pixel electrode 10 may be indium tin oxide. In other embodiment, the material of the pixel electrode 10 may be other materials. It is not limited herein.

In an embodiment, the shapes of the intermediate portion 103 in a top view may be a rectangle. In other embodiments, the shapes of the intermediate portion 103 in a top view may be other shapes. It is not limited herein.

Referring to FIG. 1B, FIG. 1B is a structural illustration in a top view of an arrangement of liquid crystal molecules controlled by an electric field after the pixel electrode shown in FIG. 1 is power-on. A broken line a in FIG. 1A may refer to a midperpendicular plane a of each of the trapezoidal portions 1011, and a broken line b in FIG. 1A may be refer to a midperpendicular plane b between two of the adjacent pairs of trapezoidal portions 1011. Corresponding to the three sub-pixel electrodes 101 in FIG. 1A, there are three broken lines a, and two broken lines b in FIG. 1B. The broken lines a in FIG. 1B may refer to the midperpendicular plane a of the pairs of trapezoidal portions 1011, and the broken lines b in FIG. 1B may refer to the midperpendicular plane b between two of the adjacent pairs of trapezoidal portions 1011. As shown in FIG. 1B, a long axis of liquid crystal molecules 102 located between the midperpendicular plane a and the midperpendicular plane b may not be perpendicular to a plane where the pixel electrode 10 is located; a long axis of liquid crystal molecules 102 located on the midperpendicular plane in the trapezoidal portion 1011 and a long axis of liquid crystal molecules 102 located on the midperpendicular plane between two of the adjacent pairs of trapezoidal portions 1011 may be perpendicular to the plane where the pixel electrode 10 is located. The long axis of liquid crystal molecules 102 perpendicular to the plane where the pixel electrode 10 is located may be not rotated, i.e., an anchoring may be formed. The active region in the sub-pixel electrode 101 where the liquid crystal molecules 102 are located may be divided into more and smaller cells, i.e., the active region where the liquid crystal molecules 102 are located may become small, so that the liquid crystal molecules 102 may reach a maximum twist angle quickly, thereby the response speed of the liquid crystal molecules 102 may be improved.

Referring to FIG. 1B, the liquid crystal molecules 102 located in the midperpendicular plane a and the midperpendicular plane b may be not rotated, i.e., the active region where the liquid crystal molecules 102 are located may be divided into four regions. A space between each the adjacent midperpendicular plane a and midperpendicular plane b may be treated as one region, and the divided region is less than four in the related art. Compared with the related art, when a size of the total active region is same, each active region of the liquid crystal molecules 102 shown in FIG. 1B becomes smaller, and the liquid crystal molecules 102 may reach the maximum twist angle quickly in a smaller region, i.e., when a distance between the adjacent midperpendicular plane a and midperpendicular plane b becomes smaller, the liquid crystal molecules 102 located in the four regions may reach the maximum twist angle in a shorter time.

In an embodiment, the liquid crystal molecules 102 may be positive liquid crystal molecules or negative liquid crystal molecules.

In a conventional FFS type liquid crystal display, the response time of the liquid crystal molecules 102 is 18 milliseconds. By a large number of experiments, the pixel electrode 10 provided by the present disclosure may shorten the response time of the liquid crystal molecules 102 to 8 milliseconds to 10 milliseconds.

When the angle between a lateral side of the trapezoidal portion 1011 and the bottom base side of the trapezoidal portion 1011 is set to 85.05 degrees, and the length of the bottom base side of the trapezoidal portion 1011 and the distance between two of the adjacent pairs of trapezoidal portions 1011 are set to 4.1 micrometers, the response time of the liquid crystal molecules 102 may be shortened to 8 milliseconds in experiments. When the length of the bottom base side of the trapezoidal portion 1011 is set to 3.6 micrometers, and the distance between two of the adjacent pairs of trapezoidal portions 1011 is set to 4.6 micrometers, the response time of the liquid crystal molecules 102 may be shortened to 9 milliseconds in experiments. When the length of the bottom base side of the trapezoidal portion 1011 is set to 4.6 micrometers, and the distance between two of the adjacent pairs of trapezoidal portions 1011 is set to 3.6 micrometers, the response time of the liquid crystal molecules 102 may be shortened to 9 milliseconds in experiments. Thus, the response speed of the liquid crystal molecules 102 may be improved by the pixel electrode 10 of the present disclosure.

As compared with the related art, the present disclosure may provide a pixel electrode comprising a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides. An active region of the pixel electrode where liquid crystal molecules are located may be divided into more and smaller cells, so that the active region where the liquid crystal molecules are located may become smaller. The liquid crystal molecules may reach a maximum twist angle quickly, thereby a response speed of a liquid crystal display may be improved.

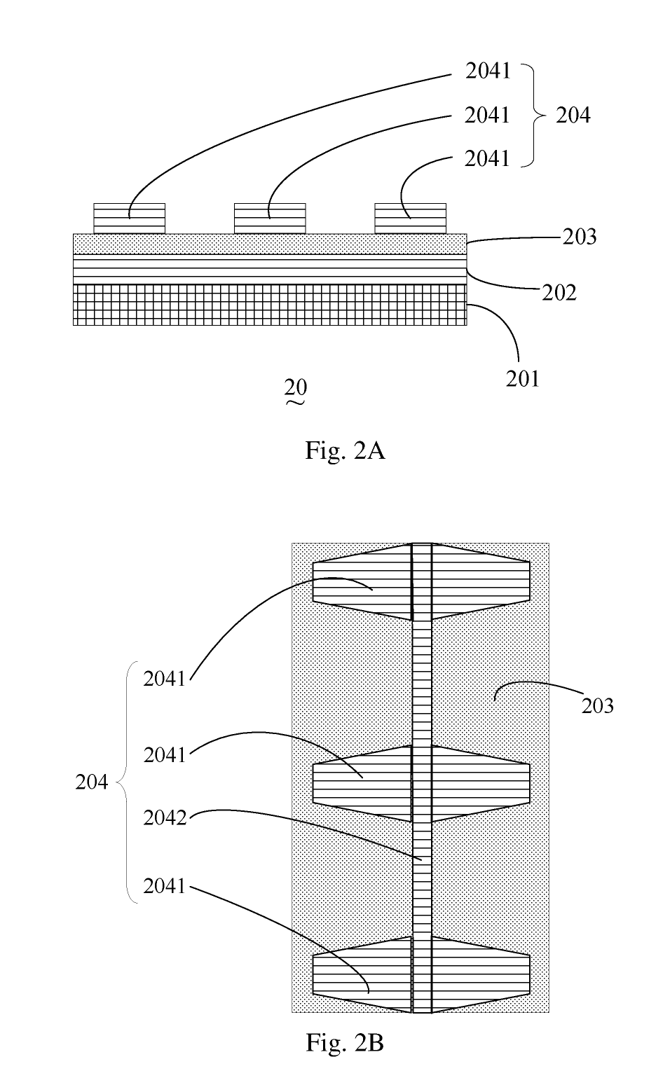

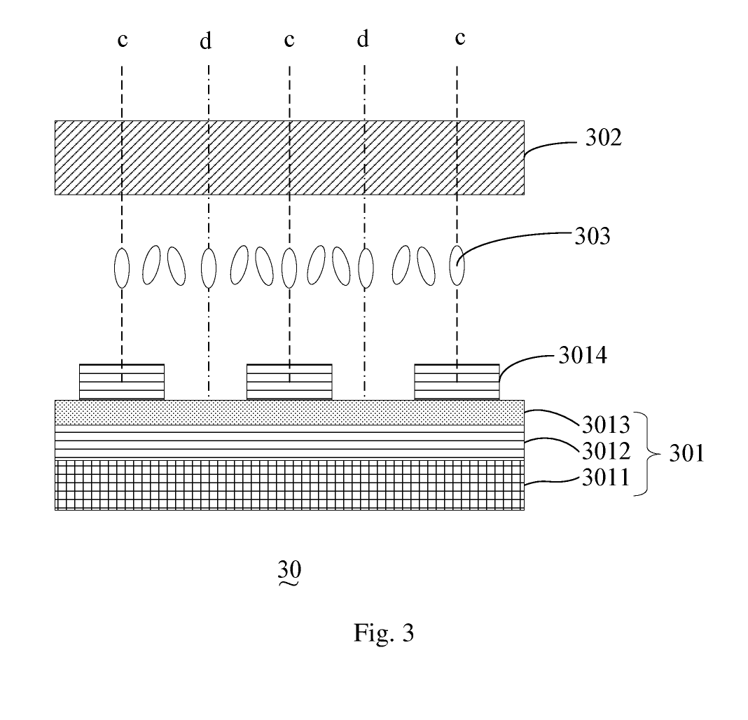

Referring to FIG. 2A and FIG. 2B, FIG. 2A is a cross section structural illustration of an array substrate in accordance with an embodiment in the present disclosure, and FIG. 2B is a structural illustration in a top view of an array substrate in accordance with an embodiment in the present disclosure. The array substrate 20 may include a substrate 201, a common electrode 202 arranged on the substrate 201, an insulating layer 203 arranged on the common electrode 202, and a pixel electrode 204 arranged on the insulating layer 203. The substrate 201 may be a glass substrate; a material of the common electrode 202 may be indium tin oxide; and a material of the insulating layer 203 may be silicon nitride or silicon oxide.

In an embodiment, the substrate 201 may be a glass substrate. In other embodiments, substrate 201 may also be a transparent plastic substrate. It is not limited herein.

In an embodiment, the pixel electrode 204 may include three sub-pixel electrodes 2041 and an intermediate portion 2042; the intermediate portion 2042 and the three sub-pixel electrodes 2041 coupled to each other by the intermediate portion 2042 may be integrated as a whole, and the whole may be treated as a single pixel electrode. In other embodiment, the pixel electrode 204 may also include two, four, five or other numbers of the sub-pixel electrodes 2041. It is not limited herein.

In an embodiment, manufacturing the array substrate 20 may include the following blocks as described.

Block 1, a substrate may be provided.

The substrate 201 may be sequentially washed by acetone, ethanol, deionized water or the like, to remove oil stains and impurities on a surface of the substrate 201, and then the substrate 201 may be dried in a nitrogen atmosphere.

Block 2, a common electrode may be formed on the substrate.

In an embodiment, a material of the common electrode 202 may be indium tin oxide. The common electrode 202 may be formed on the substrate 201 by a physical coating manner, such as a magnetron sputtering manner or an evaporation coating manner. The common electrode 202 may also be formed on the substrate 201 by an electroless coating manner. It is not limited herein. After the common electrode 202 is formed, the common electrode 202 may be subjected to a post-annealing to be more uniformly stabilized.

Block 3, an insulating layer may be formed on the common electrode.

The insulating layer 203 may be formed on the common electrode 202 by the physical or a chemical coating manner. The insulating layer 203 may protect the common electrode 202.

Block 4, a pixel electrode may be formed on the insulating layer.

A material of the pixel electrode 204 may be indium tin oxide. The indium tin oxide may be coated on the insulating layer 203, i.e., the pixel electrode 204 may be located on a side of the insulating layer 203 away from the common electrode 202. Then, the indium tin oxide layer may be patterned by a mask, to obtain the pixel electrode 204.

In an embodiment, a shape of the three sub-pixel electrodes 2041 in a top view may be a shape shown in FIG. 2B.

As compared with the related art, the present disclosure may provide a pixel electrode comprising a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides. An active region of the pixel electrode where liquid crystal molecules are located may be divided into more and smaller cells, so that the active region where the liquid crystal molecules are located may become smaller. The liquid crystal molecules may reach a maximum twist angle quickly, thereby a response speed of a liquid crystal display may be improved.

Referring to FIG. 3, FIG. 3 is a structural illustration of a liquid crystal display panel in accordance with an embodiment in the present disclosure. The liquid crystal display panel 30 may include an array substrate 301, a color filter substrate 302, and a liquid crystal layer 303 arranged between the array substrate 301 and the color filter substrate 302. The array substrate 301 may include a substrate 3011, a common electrode 3012 arranged on the substrate 3011, an insulating layer 3013 arranged on the common electrode 3012, and a pixel electrode 3014 arranged on the insulating layer 3013. The substrate 3011 may be a glass substrate; a material of the common electrode 3012 may be indium tin oxide; and a material of the insulating layer 3013 may be silicon nitride or silicon oxide. The liquid crystal molecules 303 may be positive liquid crystal molecules or negative liquid crystal molecules.

Referring to FIG. 3, a broken line c may refer to a midperpendicular plane of a sub-pixel electrode, and a broken line d may refer to a midperpendicular plane between two of the adjacent sub-pixel electrodes. There are three broken lines c and two broken lines d in FIG. 3. The broken lines c may refer to the midperpendicular plane of three of the sub-pixel electrodes, and the broken lines d may refer to the midperpendicular plane between two of the adjacent sub-pixel electrodes. As shown in FIG. 3, a long axis of liquid crystal molecules located between the midperpendicular plane c and the midperpendicular plane d may not be perpendicular to a plane where the pixel electrode 3014 is located; a long axis of liquid crystal molecules located on the midperpendicular plane c and a long axis of liquid crystal molecules located on the midperpendicular plane d may be perpendicular to the plane where the pixel electrode 3014 is located. The long axis of liquid crystal molecules perpendicular to the plane where the pixel electrode 3014 is located may be not rotated, i.e., an anchoring may be formed. An active region in the pixel electrode 3014 where the liquid crystal molecules are located may be divided into more and smaller cells, i.e., the active region where the liquid crystal molecules are located may become small, so that the liquid crystal molecules may reach a maximum twist angle quickly, thereby the response speed of the liquid crystal molecules may be improved.

In a conventional FFS type liquid crystal display, the response time of the liquid crystal molecules is 18 milliseconds. By a large number of experiments, the liquid crystal display panel 30 provided by the present disclosure may shorten the response time of the liquid crystal molecules to 8 milliseconds to 10 milliseconds. Thus, the response speed of the liquid crystal molecules may be improved by the liquid crystal display panel 30 of the present disclosure.

In an embodiment, the pixel electrode 3014 may include three sub-pixel electrodes 30141 and an intermediate portion. In other embodiment, the pixel electrode 3014 may also include other numbers of the sub-pixel electrodes. It is not limited herein

In other embodiment, a black matrix may be further arranged on the color filter substrate 302. A contrast of the liquid crystal display panel 30 may be improved by the black matrix to make the screen color vivid.

As compared with the related art, the present disclosure may provide a pixel electrode comprising a plurality of sub-pixel electrodes and an intermediate portion; the plurality of sub-pixel electrodes being coupled to each other by the intermediate portion, wherein each of the sub-pixel electrodes is more linearly narrowed from the intermediate portion away both sides. An active region of the pixel electrode where liquid crystal molecules are located may be divided into more and smaller cells, so that the active region where the liquid crystal molecules are located may become smaller. The liquid crystal molecules may reach a maximum twist angle quickly, thereby a response speed of a liquid crystal display may be improved.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

What is claimed is:

1. A pixel electrode comprising a plurality of sub-pixel electrodes and an intermediate portion; the plurality of sub-pixel electrodes being coupled to each other by the intermediate portion, wherein each of the sub-pixel electrodes is gradually linearly narrowed from the intermediate portion away both sides of the sub-pixel electrode.

2. The pixel electrode according to claim 1, wherein each of the sub-pixel electrodes comprises a pair of trapezoidal portions arranged symmetrically with the intermediate portion as an axis; the pair of trapezoidal portions are arranged opposite to each other with its bottom base sides; the bottom base sides of the pair of trapezoidal portions is connected to the intermediate portion; an angle between a lateral side of the trapezoidal portion and the bottom base side of the trapezoidal portion is 84 degrees to 87 degrees.

3. The pixel electrode according to claim 2, wherein the angle between the lateral side of the trapezoidal portion and the bottom base side of the trapezoidal portion is 84.9 degrees to 85.2 degrees.

4. The pixel electrode according to claim 2, wherein a shape of the trapezoidal portion in a top view is an isosceles trapezoid, and a shape of the intermediate portion in a top view is a rectangle.

5. The pixel electrode according to claim 4, wherein the pixel electrode comprises three pairs of trapezoidal portions; a length of the bottom base side of the trapezoidal portion is 3.6 micrometers to 4.6 micrometers; a distance between two of the adjacent pairs of trapezoidal portions is 3.6 micrometers to 4.6 micrometers.

6. The pixel electrode according to claim 4, wherein a length of the upper base side of the trapezoidal portion is greater than one quarter of the length of the bottom base side of the trapezoidal portion.

7. An array substrate comprising a pixel unit; the pixel unit comprising a plurality of sub-pixels, and each of the sub-pixels comprising a pixel electrode, wherein the pixel electrode comprises a plurality of sub-pixel electrodes and an intermediate portion; the plurality of sub-pixel electrodes are coupled to each other by the intermediate portion, wherein each of the sub-pixel electrodes is gradually linearly narrowed from the intermediate portion away both sides of the sub-pixel electrode.

8. The array substrate according to claim 7, further comprising a substrate, a common electrode, and an insulating layer arranged sequentially, and the pixel electrode being arranged on a surface of the insulating layer away from the common electrode.

9. The array substrate according to claim 7, wherein each of the sub-pixel electrodes comprises a pair of trapezoidal portions arranged symmetrically with the intermediate portion as an axis; the pair of trapezoidal portions are arranged opposite to each other with its bottom base sides; the bottom base sides of the pair of trapezoidal portions is connected to the intermediate portion; an angle between a lateral side of the trapezoidal portion and the bottom base side of the trapezoidal portion is 84 degrees to 87 degrees.

10. The array substrate according to claim 9, wherein the angle between the lateral side of the trapezoidal portion and the bottom base side of the trapezoidal portion is 84.9 degrees to 85.2 degrees.

11. The array substrate according to claim 9, wherein a shape of the trapezoidal portion in a top view is an isosceles trapezoid, and a shape of the intermediate portion in a top view is a rectangle.

12. The array substrate according to claim 11, wherein the pixel electrode comprises three pairs of trapezoidal portions; a length of the bottom base side of the trapezoidal portion is 3.6 micrometers to 4.6 micrometers; a distance between two of the adjacent pairs of trapezoidal portions is 3.6 micrometers to 4.6 micrometers.

13. The array substrate according to claim 11, wherein a length of the upper base side of the trapezoidal portion is greater than one quarter of the length of the bottom base side of the trapezoidal portion.

14. A liquid crystal display panel comprising an array substrate; the array substrate comprising a pixel unit; the pixel unit comprising a plurality of sub-pixels, and each of the sub-pixels comprising a pixel electrode, wherein the pixel electrode comprises a plurality of sub-pixel electrodes and an intermediate portion; the plurality of sub-pixel electrodes are coupled to each other by the intermediate portion, wherein each of the sub-pixel electrodes is gradually linearly narrowed from the intermediate portion away both sides of the sub-pixel electrode.

15. The liquid crystal display panel according to claim 14, further comprising a color filter substrate arranged opposite to the array substrate, and a liquid crystal layer arranged between the array substrate and the color filter substrate.

16. The liquid crystal display panel according to claim 14, wherein each of the sub-pixel electrodes comprises a pair of trapezoidal portions arranged symmetrically with the intermediate portion as an axis; the pair of trapezoidal portions are arranged opposite to each other with its bottom base sides; the bottom base sides of the pair of trapezoidal portions is connected to the intermediate portion; an angle between a lateral side of the trapezoidal portion and the bottom base side of the trapezoidal portion is 84 degrees to 87 degrees.

17. The liquid crystal display panel according to claim 16, wherein the angle between the lateral side of the trapezoidal portion and the bottom base side of the trapezoidal portion is 84.9 degrees to 85.2 degrees.

18. The liquid crystal display panel according to claim 16, wherein a shape of the trapezoidal portion in a top view is an isosceles trapezoid, and a shape of the intermediate portion in a top view is a rectangle.

19. The liquid crystal display panel according to claim 18, wherein the pixel electrode comprises three pairs of trapezoidal portions; a length of the bottom base side of the trapezoidal portion is 3.6 micrometers to 4.6 micrometers; a distance between two of the adjacent pairs of trapezoidal portions is 3.6 micrometers to 4.6 micrometers.

20. The liquid crystal display panel according to claim 18, wherein a length of the upper base side of the trapezoidal portion is greater than one quarter of the length of the bottom base side of the trapezoidal portion.
